(19) United States
(12) Patent Application Publication
(10) Pub. No.: US 2023/0287187 A1
(43) Pub. Date: Sep. 14, 2023

(54) Use of carbon-nanofibers comprising carbon networks

(71) Applicant: CarbonX IP 6 B.V., Amsterdam (NL)

(72) Inventors: Rutger Alexander David Van Raalten, Amsterdam (NL); Daniela Sordi, Amsterdam (NL); Jeroen ten Dam, Amsterdam (NL)

(73) Assignee: CarbonX IP 6 B.V., Amsterdam (NL)

(21) Appl. No.: 17/779,153

(22) PCT Filed: Nov. 27, 2020
(86) PCT No.: PCT/EP2020/083690

§ 371 Date: May 24, 2022

(30) Foreign Application Priority Data
Nov. 28, 2019 (EP) 19212328.9

(51) Int. Cl. C08J 5/04

(52) U.S. Cl. CPC C08J 5/042; C08J 2300/24

(57) ABSTRACT

The invention pertains to the use of porous, chemically interconnected, carbon-nanofiber comprising carbon networks for reinforcing thermosetting material as well as to the reinforced material. In one aspect, the invention relates to the use of at least 0.1 wt %, more preferably at least 0.5 wt %, even more preferably at least 1 wt %, even more preferably at least 2 wt %, most preferably at least 3 wt. %, preferably 2-60 wt. %, more preferably 3-50 wt %, more preferably 5-45 wt % of a porous, chemically interconnected, carbon-nanofibers-comprising carbon network for reinforcing carbon-based fiber in a thermoset material, said weight based on the total weight of the reinforced thermoset material.

### FIELD OF THE INVENTION

The invention pertains to reinforcement of thermosets, particularly reinforcing thermosetting composites and use of such reinforced thermoset composites, in order to arrive at composites having improved mechanical properties such as stiffness, tensile strength, shear strength, compressive strength, durability, fatigue resistance, glass transition temperature, electrical conductivity, thermal conductivity and impact strength.

### BACKGROUND TO THE INVENTION

A thermosetting plastic, or simply a thermoset, is a rigid, irreversibly cured resin which is very resilient to all kinds of outside influences such as high temperatures, outside forces, abrasion and corrosion. This behaviour is often considered beneficial and it makes thermosets a preferred choice for many applications, which include automotive applications, household appliances, lighting, as well as industrial machinery and oil and gas applications. Common thermosetting resins include polyester resin, vinyl ester resin, epoxy, phenolic, urethane, polydicyclopentadiene, cyanate esters (CEs), bismaleimides (BMIs), silicons, melamine formaldehyde, phenol formaldehyde, urea formaldehyde, diallyl phthalate, benzoxazines, polyimides, furan resins, or polyamides.

The thermoset curing process starts with monomers or oligomers. These monomers or oligomers typically form a low viscous liquid. Curing starts when these monomers or oligomers start reacting, for instance due to the addition of heat. With curing the viscosity of the materials increases, forming a permanently cross-linked, rigid network ultimately. As a result, the material cannot be brought back into its liquid state. This is different from thermoplastics forming physical bonds between polymers which can be broken, for instance upon heating. Thermoplastics are solid or solid-like when cooled but will become fluid when heated.

A benefit of thermosets is the ability to mix in additives, such as impregnation agents or reinforcements, with the resin before curing. After curing these additives are trapped in the thermoset matrix resulting in thermoset with specific properties. Using this technique, fiber-reinforced plastics can be made, examples of which are carbon fiber reinforced plastic (CFRP) and glass fiber reinforced plastic (GFRP). These are composites where long fibers have been included, typically in a woven structure, in the resin which results in a very strong end-product when looked at it in the direction of the fibers. However, perpendicular to the fibers there will hardly be any reinforcement.

Instead of using long fibers, it is possible to mix in chopped fibers into the resin mix before curing. These chopped fibers are typically one or several millimetres in size. The benefit of using these chopped fibers is that they can simply be mixed into the resin without the need for alignment rendering them easy to process. This will yield a three-dimensional fiber structure within the material that provides strength in all directions. A common issue in moulding thermosets using processes such as compression, injection and transfer moulding is that the fibers align with the direction of the flow causing anisotropy of properties. Besides that, the strength of randomly oriented fibers will be lower compared to the strength of fiber reinforced plastics parallel with the fiber length. Similarly, it may be beneficial to add chopped prepregs-small mm sized particles comprising resin and a reinforcing aid—to a resin.

In reinforced composites a major issue with fibers (mats, chopped, strands etc) is delamination caused by mechanical stress, heat, moisture uptake, ageing and combinations thereof. With ‘delamination’ it is understood the separation of the resin and the fibers at their interface. Moreover, the thermoset mechanical properties usually deteriorate above the glass transition temperature (defined as the temperature at which a polymer goes from a rubbery state to a brittle glass-like state).

Hence there is a dire need for improving reinforcement of thermosets with an upshift of glass transition temperature to widen the operating window.

### SUMMARY TO THE INVENTION

It has now been found that a particular grade of carbon-nanofibers-comprising carbon networks can beneficially be used to reinforce thermosets material either alone or improve the interaction between reinforcing agents and a thermoset matrix. In reinforced composites a major issue with fibers (mats, chopped, strands etc) is delamination caused by mechanical stress, heat, moisture uptake, ageing and combinations thereof. The term ‘delamination’ refers to the separation of resin and fibers at their interface. It is believed without wishing to being bound to any theory that carbon fibers-comprising carbon networks function as an interface compatibilizer between thermoset material and reinforcing fibers. The carbon networks can thus be used to prevent or reduce delamination issues between thermosets and reinforcing agents. This particular grade is a porous, chemically interconnected, carbon-nanofibers-comprising carbon network as detailed further below.

The benefits of the carbon networks are twofold: on the one hand it is found that significant amounts of these networks help in reinforcing thermoset materials, and particularly also in terms of other mechanical properties such as (a) the stiffness of the thermoset material, (b) the tensile strength of the thermoset material, (c) the shear strength of the thermoset material, (d) the compressive strength of the thermoset material, (e) the durability of the thermoset material, (f) the fatigue resistance of the thermoset material, (g) the glass transition temperature of the thermoset material, (h) the electrical conductivity of the thermoset material, (i) the thermal conductivity of the thermoset material, and/or (j) the impact strength of the thermoset material. In each of (a)-(j), the improvement achieved by the reinforcement is compared to the reference thermoset material without the carbon networks. Conveniently, when using these networks as the sole reinforcing agent, there are no delamination issues. In addition, carbon-nanofibers-comprising carbon networks may add additional features to the reinforced material, such as electrical and thermal conductivity, UV protection and glass transition temperature upshift. Moreover, it was found that the carbon networks can also be added for compatibilizing or improving the adhesive interaction between the thermoset material and conventional thermoset reinforcing agents such as carbon fibers, glass fibers, aramids, natural fibers, carbon nanotubes, carbon nanofibers, silicon nanotubes and nanoclays.

Either way, the carbon network is preferably added in amounts of at least 0.1 wt %, more preferably at least 0.5 wt %, even more preferably at least 1 wt %, even more preferably at least 2 wt %, most preferably at least 3 wt. %, preferably 2-60 wt. %, more preferably 3-50 wt %, more preferably 5-45 wt %, based on the total weight of the reinforced material. When the carbon networks are added together with a reinforcing agent, it is preferred that the total amount of carbon networks and the reinforcing agent(s) is between 1 and 75 wt %, more preferably between 10 and 45 wt %, based on the total weight of the reinforced thermoset. In this context, the carbon networks are not encompassed in the term ‘reinforcing agent’.

As detailed below, the carbon networks of the invention are preferably characterized in that they form an intraparticle porous network wherein the carbon nanofibers are interconnected to other carbon nanofibers in the network by chemical bonds via junctions, wherein the pores in the network have an intraparticle pore diameter size of 5-150 nm using Mercury Intrusion Porosimetry according to ASTM D4404-10, wherein at least 20 wt % of the carbon in the carbon networks is in crystalline form, and the carbon nanofibers have an average aspect ratio of fibre length-to-thickness of at least 2.

The reinforced thermoset material according to the invention can be used in all fields where thermoset materials are traditionally used. This includes all sorts of moulded parts that can, for instance, be used in the semi-conductor industry. The reinforced thermoset material of the invention allows to make parts lighter, electrostatic dissipative or highly conductive, with wider temperature processing windows and easier to process without compromising on their strength or other mechanical properties and without effecting the viscosity dramatically. This makes the reinforced thermoset material of the invention particularly suitable in the aerospace industry, the car industry and the likes. It allows to make lighter aircrafts, trains, boats, cars, bikes which may in turn result in increased performance such as faster acceleration or improved fuel economy. In addition, the limited effect on viscosity enables maximum freedom-of-design, allowing a product designer to create more detailed and complex shapes. The materials preferably replace conventional reinforced thermosets used in automotive, aerospace, space, marine or oil & gas industry, or in particular lightweight radiators used for de-icing wind turbines.

### BRIEF DESCRIPTION OF THE DRAWINGS

FIG. 1A is a schematic diagram of a continuous furnace carbon black producing process in accordance with the present invention which contains, along the axis of the reactor 3, a combustion zone 3a, a reaction zone 3b and a termination zone 3c, by producing a stream of hot waste gas a1 in the combustion zone by burning a fuel a in an oxygen-containing gas b and passing the waste gas a1 from the combustion zone 3a into the reaction zone 3b, spraying (atomizing) a single-phase emulsion c in the reaction zone 3b containing the hot waste gas, carbonizing said emulsion at increased temperature, and quenching or stopping the reaction in the termination zone 3c by spraying in water d, to obtain crystalline carbon networks e according to the invention;

FIG. 1B is a schematic diagram of a semi-batch carbon black producing process where a single-phase emulsion c is atomized through a nozzle 4 at the top of the reactor 3 into the reactor zone 3b at elevated temperatures, carbonizing said emulsion at the elevated temperature in the reactor zone 3b, and collecting the crystalline carbon networks e at the bottom of the reactor. Additionally two gas-inlets are present that enter the reactor from the top, for adding inert gas f, preferably nitrogen for controlling and/or depletion of oxygen-levels, and for introducing a carbon-containing gas g into the reactor, preferably acetylene or ethylene.

FIGS. 2 and 3 depict surface sensitivity vs carbon network loading, both in longitudinaal and transverse direction.

FIG. 4 shows Emodulus vs carbon network loading.

FIG. 5 presents tensile strength vs carbon network loading.

FIG. 6 shows thermal conductivity vs carbon network loading (loggemet and excel indicate which program sources was used for raw data conversion).

FIG. 7 plots G′/G″ crossover data vs carbon network loading.

### CLAUSES OF THE INVENTION

1. Use of at least 0.1 wt %, more preferably at least 0.5 wt %, even more preferably at least 1 wt %, even more preferably at least 2 wt %, most preferably at least 3 wt. %, preferably 2-60 wt. %, more preferably 3-50 wt %, more preferably 5-45 wt % of a porous, chemically interconnected, carbon-nanofibers-comprising carbon networks for reinforcing a thermoset material, said weight based on the total weight of the reinforced thermoset material.
2. Use according to clause 1, wherein the reinforced thermoset material comprises additional reinforcing agent(s), wherein the total amount of carbon networks and the additional reinforcing agent(s) is between 1 and 75 wt %, more preferably between 10 and 45 wt % of the total weight of the reinforced thermoset material.
3. Use according to clause 1 or 2, wherein the amount of additional reinforcing agent(s) is between 1 and 45 wt %, preferably between 5 and 40 wt %, more preferably between 10 and 35 wt %, most preferably between 15 and 30 wt %, based on the total weight of the reinforced thermoset material.
4. Use according to any one of the preceding clauses wherein the amount of said carbon network is between 5 and 60 wt %, preferably below 45 wt %, even more preferably below 35%.
5. Use according to any one of clauses 2-4, wherein the further reinforcing agent comprises carbon fibers, glass fibers, aramids, natural fibers, carbon nanotubes, carbon nanofibers, silicon nanotubes, nanoclays.
6. Use according to any one of the preceding clauses, for improving one or more of the following properties of the thermoset material:
   (a) the electrical conductivity of the thermoset material;
   (b) the glass transition temperature of the thermoset material;
   (c) the stiffness of the thermoset material;
   (d) the tensile strength of the thermoset material;
   (e) the shear strength of the thermoset material;
   (f) the compressive strength of the thermoset material;
   (g) the impact strength of the thermoset material;
   (h) the durability of the thermoset material;
   (i) the fatigue resistance of the thermoset material; and/or
   (j) the thermal conductivity of the thermoset material.
7. A reinforced thermoset material comprising at least 0.1 wt %, more preferably at least 0.5 wt %, even more preferably at least 1 wt %, even more preferably at least 2 wt %, most preferably at least 3 wt. %, preferably 2-60 wt. %, more preferably 3-50 wt %, more preferably 5-45 wt % of a porous, chemically interconnected, carbon-nanofiber-comprising carbon network.
8. The reinforced thermoset material according to clause 7, comprising additional reinforcing agent(s), wherein the total amount of carbon networks and reinforcing agent(s) other than said carbon networks is between 1 and 75 wt %, more preferably between 10 and 45 wt % of the total weight of the reinforced thermoset material.
9. The reinforced thermoset material according to clause 7 or 8, wherein the amount of further reinforcing agent is between 1 and 45 wt %, preferably between 5 and 40 wt %, more preferably between 10 and 35 wt %, most preferably between 15 and 30 wt %, based on the total weight of the reinforced thermoset material.
10. The use according to any one of clauses 1-6 or the reinforced thermoset material according to any one of clauses 7-9, wherein the carbon network comprises crystalline carbon-nanofibers.
11. Use according to any one of clauses 1-6 or 10 or the reinforced thermoset material according to any one of clauses 7-10, wherein the carbon network is an intraparticle porous network.
12. Use according to any one of clauses 1-6 or 10-11 or the reinforced thermoset material according to any one of clauses 7-11, wherein the average fiber length of the carbon-nanofibers is 30-10,000 nm.
13. Use according to any one of clauses 1-6 or 10-12 or the reinforced thermoset material according to any one of clauses 7-12, wherein the thermoset material is any one of unsaturated polyester resin, vinyl ester resin, epoxy, phenolic, urethane, polydicyclopentadiene, cyanate esters (CEs), bismaleimides (BMIs), silicons, melamine formaldehyde, phenol formaldehyde, urea formaldehyde, diallyl phthalate, benzoxazines, polyimides, furan resins, or polyamides.
14. Use according to any one of clauses 1-6 or 10-13 or the reinforced thermoset material according to any one of clauses 7-13, wherein the carbon networks are obtainable by a process for producing crystalline carbon networks in a reactor 3 which contains a reaction zone 3b and a termination zone 3c, by injecting a water-in-oil or bicontinuous micro-emulsion c comprising metal catalyst nanoparticles, into the reaction zone 3b which is at a temperature of above 600° C., preferably above 700° C., more preferably above 900° C., even more preferably above 1000° C., more preferably above 1100° C., preferably up to 3000° C., more preferably up to 2500° C., most preferably up to 2000° C., to produce crystalline carbon networks e, transferring these networks e to the termination zone 3c, and quenching or stopping the formation of crystalline carbon networks in the termination zone by spraying in water d.
15. An article of manufacture comprising the reinforced thermoset material according to any one of clauses 7-14, said article for example being a coating, an adhesive, a reinforcing element, a heating element, automotive part or a construction element, or a lightweight reinforced radiator for wind turbines and airplane.

### DETAILED DESCRIPTION

The invention can be described as the use of at least 0.1 wt %, more preferably at least 0.5 wt %, even more preferably at least 1 wt %, even more preferably at least 2 wt %, most preferably at least 3 wt. %, preferably 2-60 wt. %, more preferably 3-50 wt %, more preferably 5-45 wt % of porous, chemically interconnected, carbon-nanofibers-comprising carbon networks for reinforcement in a thermoset material, the weight based on total weight of the reinforced thermoset material.

The invention can also be worded as a reinforced thermoset material comprising at least 0.1 wt %, more preferably at least 0.5 wt %, even more preferably at least 1 wt %, even more preferably at least 2 wt %, most preferably at least 3 wt. %, preferably 2-60 wt. %, more preferably 3-50 wt %, more preferably 5-45 wt %, of porous, chemically interconnected, carbon-nanofiber-comprising carbon networks, based on the total weight of the reinforced thermoset material.

In a further aspect, the invention pertains to the use of at least 0.1 wt %, more preferably at least 0.5 wt %, even more preferably at least 1 wt %, even more preferably at least 2 wt %, most preferably at least 3 wt. %, preferably 2-60 wt. %, more preferably 3-50 wt %, more preferably 5-45 wt % of a porous, chemically interconnected, carbon-nanofibers-comprising carbon network for preventing or decreasing delamination of a reinforced thermoset material.

The thermoset material may be any suitable thermoset material and preferably is any one of unsaturated polyester resin, vinyl ester resin, epoxy, phenolic, urethane, polydicyclopentadiene, cyanate esters (CEs), bismaleimides (BMIs), silicons, melamine formaldehyde, phenol formaldehyde, urea formaldehyde, diallyl phthalate, benzoxazines, polyimides, furan resins and/or polyamides.

Using the reinforced thermoset material of the invention it is possible to produce articles of manufacture such as reinforced automotive parts. It allows to make better and/or lighter parts (i.e. with less weight) that may help to make reduce weight in car construction and thereby improve fuel economy. The reinforced material of the invention may also be applied as a coating, adhesive, reinforcing element, heating element, construction element. Hence, in a preferred embodiment, the article is a coating, an adhesive, a reinforcing element, a heating element, automotive part or a construction element, or a lightweight reinforced radiator for wind turbines and airplane.

The carbon network comprises fibers which may be crystalline carbon-nanofibers and which may have an average fiber length of 30-10,000 nm. Furthermore, the carbon network may be an intraparticle porous network.

In a preferred embodiment, the total amount of reinforcing agent (i.e. the sum of carbon network and reinforcing agent different from the porous, chemically interconnected, carbon-nanofibers-comprising carbon network) is at least 1 wt %, preferably between 1 and 75 wt %, more preferably between 10 and 45 wt %, based on total weight of the reinforced thermoset material. In one embodiment, the carbon network provide the sole reinforcement (i.e. there is no additional reinforcing agent added); in another embodiment, it is preferred that the carbon network is added together with one or more additional reinforcing agent(s).

The carbon networks compatibilize and improve adherence of conventional reinforcing agent(s) with the thermoset material, thus improving reinforcement properties compared to reinforced thermoset material with the same total amount of reinforcing agent but without such carbon networks.

The amount of additional reinforcing agent(s) (i.e. reinforcing agent(s) different from the porous, chemically interconnected, carbon-nanofibers comprising carbon network) is preferably between 1 and 45 wt %, more preferably between 5 and 40 wt %, even more preferably between 10 and 35 wt %, most preferably between 15 and 30 wt %, based on the total weight of the reinforced thermoset material. In such embodiments, the amounts of carbon networks may be kept at a cost-effective minimum, preferably between 5 and 45 wt %, preferably below 40 wt %, even more preferably below 30%.

Non-limiting examples of traditional reinforcing agents suitable for reinforcing thermoset materials are carbon fibers, glass fibers, aramids, natural fibers, carbon nanotubes, carbon nanofibers, silicon nanotubes. These are distinct from the carbon networks which also comprise carbon fibers since the latter fibers are chemically connected within the network, while the additional reinforcing agents are not covalently connected to said carbon networks.

Thermosets have their conventional meaning in the art. It is understood that a thermoset material is a rigid, highly cross-linked material made by cross-linking a liquid resin. In the art thermoset materials are often shortened to thermosets. For the purpose of the current invention and throughout this text, the terms thermoset material and thermoset are equal and have exactly the same meaning.

The invention extends to all thermosetting materials that are produced from a monomer, oligomer or prepolymer resin. Suitable examples of thermosetting materials include unsaturated polyester resin, vinyl ester resin, epoxy, phenolic, urethane, polydicyclopentadiene, cyanate esters (CEs), bismaleimides (BMIs), silicons, melamine formaldehyde, phenol formaldehyde, urea formaldehyde, diallyl phthalate, benzoxazines, polyimides, furan resins and/or polyamides. Thermosets are characterized by becoming irreversibly hard on heating, UV-light irradiation, or by addition of special chemicals, such as hardening agents. This hardening, which is referred to as curing in the art, involves a chemical change. During curing the molecules of the resin—which are short molecules such as monomers or oligomers—are connected together to form polymers. Said polymers are subsequently connected to one another by crosslinks. The amount polymers that is linked to other polymers compared to the total amount of polymers is denoted the degree of crosslinking. Crosslinking is usually very extensive, meaning that at least 10%, preferably at least 25%, more preferably at least 35% and most preferably at least 50% of the polymers are crosslinked. Thermosets are harder, stronger and more brittle than other types of polymeric materials such as elastomers or thermoplastic.

The glass transition temperature (Tg) defined as the temperature at which a polymer goes from a rubbery state to a brittle glass-like state. Thermosets have a glass temperature which is higher than room temperature making them hard and brittle. Elastomers, on the contrary, have a glass temperature below room temperature causing a soft and rubbery behavior. Tg has therefore a significant effect on mechanic properties of the thermoset composite. The thermoset mechanical properties will significantly deteriorate above Tg. Hence, an increase in Tg results in a wider operating window of said composite. Tg is a result of the propensity of the polymeric chains to move within the polymeric matrix. Adding small molecules (softener) will lower Tg, whereas longer more rigid polymeric molecules will increase Tg. Therefore, an increase of Tg as a result of the addition of a carbon additive is an indication that the mobility of the polymeric chain is reduced and the chains are immobilised, which in itself is an indication of a strong carbon-polymer interaction. This strong carbon-polymer interaction can be linked to improved mechanical properties.

The carbon network are preferably included in the reinforced thermoset in amounts of at least 0.1 wt %, more preferably at least 0.5 wt %, even more preferably at least 1 wt %, even more preferably at least 2 wt %, most preferably at least 3 wt. %, preferably 2-60 wt. %, more preferably 3-50 wt %, more preferably 5-45 wt % of the total weight of the reinforced thermoset. Alternatively the inclusion level is 0.1-60 wt. %, more preferably 1-60 wt. %, even more preferably 2-60 wt. %, still more preferably 3-50 wt. %, most preferably 5-45 wt. %, particularly at least 5 wt % of the total weight of the reinforced thermoset.

Reinforcing refers to increasing the mechanical properties of a material, wherein the mechanical properties may by one or more of tensile strength, stiffness, compressive strength, shear strength, hardness, compressive strength, durability, fatigue resistance, etc. Here the wording “increased” (or: ‘improved’) is used to indicate an increment in the property of a reinforced thermoset material compared to a thermoset material not comprising a porous, chemically interconnected, carbon-nanofibers comprising carbon network.

Preferably the reinforced thermoset has an increased tensile strength. The increase in tensile strength may be at least 1 MPa, more preferably 5 MPa, even more preferred 10 MPa. Preferably the increase in tensile strength due to the carbon networks is at least 5%, preferably at least 20% and more preferably at least 50% compared to the thermoset without the carbon networks.

Preferably the reinforced thermoset has an increased stiffness. The increased stiffness may be at least 1.3 GPa, more preferably 2 GPa, and even more preferred 6 GPa. Preferably the increase in stiffness due to the carbon networks is at least 20%, preferably at least 50%, more preferably at least 100% and more preferably at least 200% compared to the thermoset without the carbon networks.

The reinforced thermoset may have an increased hardness. The shore D hardness may be at least 55, more preferably at least 65 and even more preferred at least 75. The increase in shore D hardness may be least 20%, preferably at least 40% and more preferably at least 60% compared to the thermoset without the carbon networks.

The compression strength may be at least 10 MPa, more preferably 50 MPa, even more preferred 100 MPa. Preferably the reinforced thermoset has an increased shear strength. Preferably the increase in compression strength due to the carbon networks is at least 20%, preferably at least 40% and more preferably at least 60% compared to the thermoset without the carbon networks.

The Tg of the reinforced thermoset may be increased by at least 2° C., preferably at least 5° C. and more preferably at least 10° C. compared to the thermoset without the network filler. The reinforced thermoset preferably has an electrical conductivity of at least 10⁸ ohm/sq, preferably between 10⁸ Ohm/sq and 10 Ohm/sq. The reinforced thermoset is preferably characterized by an impact strength of at most 10 J/cm² preferably between 0.1 and 10 J/cm².

The reinforced thermoset preferably has a thermal conductivity of at least 0.2 W/m·K, preferably between 0.2 W/m·K and 1 W/m·K.

Preferably the reinforced thermoset has an increased durability wherein durability refers to the water uptake from alkaline, acidic or saline solution as well as to the mechanical properties after water uptake from the relevant solution. The durability may be such that the mechanical properties—wherein the mechanical properties are defined as above—do not change upon soaking for at least 5 weeks, more preferably at least 15 weeks, even more preferably at least 30 weeks and most preferably at least 50 weeks in an alkaline, acidic or saline solution. Durability can for instance be assessed in accordance with the test provided in 18th International Conference on Composites materials, EFFECTS OF CHEMICAL ENVIRONMENT ON THE DURABILITY PERFORMANCES OF GLASS FIBER/EPOXY COMPOSITES, A. Bo Sun, B. Yan Li, its contents herewith incorporated by reference. The investigation involves considering a number of exposures including immersion in three different solutions: deionized water, salt water, and alkaline solution, and monitoring the response over the above period through moisture uptake measurements, mechanical characterization, and dynamic mechanical analysis. In addition, microscopic photos can be obtained before and after the immersion, which could be analyzed by means of Fourier transform infrared spectroscopy (FTIR).

Preferably the reinforced thermoset has an increased fatigue resistance. The fatigue resistance, when tested at room temperature using alternating bending with stress ratio (R)σₘᵢₙ/σₘₐₓ=−1 and loading frequency 5 Hz, under constant displacement of U=20 mm, may be at least 1000 cycles, more preferably at least 3000 cycles, even more preferably at least 7000 cycles. The increase in fatigue resistance may be at least 20%, preferably at least 40% and more preferably at least 60% compared to the thermoset without the carbon networks.

Preferably the reinforced thermoset has an increased stiffness, an increased tensile strength, an increased durability and/or an increase fatigue resistance.

The invention may also be worded as a reinforced thermoset material comprising the aforementioned numbers of a porous, chemically interconnected, carbon-nanofiber comprising carbon network, and optionally additional reinforcement agent(s) as mentioned here above.

The skilled person will understand that a porous network refers to a 3-dimensional structure that allows fluids or gasses to pass through. A porous network may also be denoted as a porous medium or a porous material. The pore volume of the porous carbon networks according to the invention is 0.05-5 cm³/g, preferably 0.1-4 cm³/g, more preferably 0.5-3.5 cm³/g and most preferably 0.9-3 cm³/g as measured using Mercury Intrusion Porosimetry (ASTM D4404-10).

The carbon-nanofiber comprising carbon networks may have an intraparticle pore diameter size as measured using Mercury Intrusion Porosimetry (ASTM D4404-10) of 5-200 nm, preferably 10-150 nm, and most preferably of 20-130 nm. Following the same ASTM test method, the networks may have an interparticle pore diameter of 10-500 μm, more preferably 80-400 μm.

The carbon-nanofiber-comprising carbon networks may have an intraparticle volume as measured using Mercury Intrusion Porosimetry (ASTM D4404-10) of 0.10-2.0 cm³/g, preferably 0.5-1.5 cm³/g, and most preferably of 0.5-1.2 cm³/g.

A porous carbon network according to the invention or a porous crystalline carbon network particle of the invention can be seen as a big molecule, wherein the carbon atoms inherently are covalently interconnected. It is hereby understood that a porous carbon network particle is a particle comprising a porous carbon networks, having intraparticle porosity, as opposed to interparticle porosity which refers to a porous network created by multiple molecules or particles and wherein the pores are formed by the space between physically aggregated particles or molecules. In the context of the current invention, intraparticle porosity may also be denoted as intramolecular porosity as the carbon network particle according to the invention can be seen as a big molecule, wherein the pores are embedded. Hence intraparticle porosity and intramolecular porosity have the same meaning in the current text and may be used interchangeably. Without being bound to a theory, it is believed that the benefit of having a crystalline network with intraparticle porosity over a(n amorphous) network with interparticle porosity is that the first are more robust and more resilient against crushing and breaking when force is applied. Known reinforcing agents, such as carbon black, consist of aggregates or agglomerates of spherical particles that may form a 3-dimensional structure, where spheres are fused with amorphous connections weaker porosity. Summarizing, intraparticle porosity refers to the situation wherein the carbon atoms surrounding the pores are covalently connected in crystalline form, wherein interparticle porosity refers to pores residing between particles which are physically aggregated, agglomerated, or have amorphous connections.

As the networks of the invention can be seen as one big molecule, there is no need to fuse particles or parts of the network together. Hence it is preferred that the porous, chemically interconnected, carbon-nanofiber comprising carbon networks are non-fused, intraparticle porous, chemically interconnected, crystalline carbon-nanofiber-comprising carbon networks, having intraparticle porosity. In a preferred embodiment, the intraparticle pore volume may be characterized as described further below, e.g. in terms of Mercury Intrusion Porosimetry (ASTM D4404-10) or Nitrogen Absorption method (ISO 9277:10).

The skilled person will readily understand that the term chemically interconnected in porous, chemically interconnected, carbon-nanofiber comprising carbon networks implies that the carbon-nanofiber crystallites are interconnected to other carbon-nanofibers by chemical bonds. It is also understood that a chemical bond is a synonym for a molecular or a covalent bond. Typically those places where the carbon-nanofibers are connected are denoted as junctions or junctions of fibers, which may thus be conveniently addressed as ‘covalent junctions’ These terms are used interchangeable in this text. In the carbon networks according to the invention, the junctions are formed by covalently connected carbon crystals. It furthermore follows that the length of a fiber is defined as the distance between junctions which are connected by fibrous carbon material.

In order to achieve the above, at least part of the fibers in the carbon-nanofiber comprising networks of the invention are crystalline carbon-nanofibers. Preferably at least 20 wt. % of the carbon in the carbon networks in the invention is crystalline, more preferably at least 40 wt. %, even more preferably at least 60 wt. %, even more preferably at least 80 wt. % and most preferably at least 90 wt. %. Alternatively the amount of crystalline carbon is 20-90 wt. %, more preferably 30-70 wt. %, and more preferably 40-50 wt. % compared to the total carbon in the carbon networks of the invention.

Here ‘crystalline’ has its usual meaning and refers to a degree of structural order in a material. In other words the carbon atoms in the nanofibers are to some extent arranged in a regular, periodic manner. The areas or volumes which are crystalline can be denoted as crystallites. A carbon crystallite is hence an individual carbon crystal. A measure for the size of the carbon crystallites is the stacking height of graphitic layers. Standard ASTM grades of carbon black have a stacking height of the graphitic layers within these crystallites ranging from 11-13 Å (angstroms). The carbon-nanofiber-comprising carbon networks of the invention preferably have a stacking height of at least 15 Å (angstroms), preferably at least 16 Å, more preferably at least 17 Å, even more preferably at least 18 Å, even more preferably at least 19 Å and still more preferably at least 20 Å. If needed the carbon networks with crystallites as large as 100 Å (angstroms) can be produced. Hence the carbon networks of the invention have a stacking height of 15-100 Å (angstroms), more preferably of up to 80 Å, even more preferably of up to 60 Å, even more preferably of up to 40 Å, still more preferably of up to 30 Å. It is therefore understood that the stacking height of graphitic layers within crystallites in the carbon networks of the invention is 15-90 Å (angstroms), more preferably 16-70 Å, even more preferably 17-50 Å, still more preferably 18-30 Å and most preferably 16-25 Å.

The porous, chemically interconnected, carbon-nanofiber comprising carbon networks may be defined as chemically interconnected carbon-nanofibers, wherein carbon-nanofibers are interconnected via junction parts, wherein several (typically 3 or more, preferably at least 10 or more) nanofibers are covalently joined. Said carbon-nanofibers are those parts of the network between junctions. The fibers typically are elongated bodies which are solid (i.e. non-hollow), preferably having an average diameter or thickness of 1 500 nm, preferably of 5-350 nm, more preferably up to 100 nm, in one embodiment 50-100 nm, compared to the average particle size of 10-400 nm for carbon black particles. In one embodiment, the average fiber length (i.e. the average distance between two junctions) is preferably in the range of 30-10,000 nm, more preferably 50-5,000 nm, more preferably 100-5,000 nm, more preferably at least 200-5,000 nm, as for instance can be determined using SEM.

The nanofibers or structures may preferably be described in terms of an average aspect ratio of fiber length-to-thickness of at least 2, preferably at least 3, more preferably at least 4, and most preferably at least 5, preferably at most below 50; in sharp contrast with the amorphous (physically associated) aggregates formed from spherical particles obtained through conventional carbon black manufacturing.

The carbon-nanofiber structures may be defined as crystalline carbon networks formed by chemically interconnected carbon-nanofibers. Said carbon networks have a 3-dimensional configuration wherein there is an opening between the carbon-nanofibers that is accessible to a continuous phase, which may be a liquid—such as a solvent or an aqueous phase —, a gas or any other phase. Said carbon networks are at least 0.5 μm in diameter, preferably at least 1 μm in diameter, preferably at least 5 μm in diameter, more preferably at least 10 μm in diameter, even more preferably at least 20 μm in diameter and most preferably 25 μm in all dimensions. Alternatively said carbon networks are at least 1 μm in diameter in 2 dimensions and at least 5 μm in diameter, preferably at least 10 μm in diameter, more preferably a least 20 μm in diameter and most preferably at least 25 μm in diameter in the other dimension. Here, and also throughout this text, the term dimension is used in its normal manner and refers to a spatial dimension. There are 3 spatial dimensions which are orthogonal to each other and which define space in its normal physical meaning. It is furthermore possible that said carbon networks are at least 10 μm in diameter in 2 dimensions and at least 15 μm in diameter, preferably at least 20 μm in diameter, more preferably a least 25 μm in diameter, more preferably at least 30 μm in diameter and most preferably at least 50 μm in diameter in the other dimension. These measurements are based on laser diffraction.

The carbon-nanofiber-comprising carbon networks may have a volume-based aggregate size as measured using laser diffraction (ISO 13320-1) or dynamic light scattering analysis of 0.1-100 μm, preferably 1-50 μm, more preferably 1-40 μm, more preferably of 5-35 μm, more preferably of 5-25 μm and most preferably of 5-20 μm. The networks preferably have an advantageously narrow particle size distribution, particularly compared to traditional carbon black. The particle size distribution may be characterized between 10 and 200 nm, preferably 10-100 nm as determined using the transmission electronic microscope and measuring the diameter of the fibers.

The networks may be characterized by an aggregate strength between 0.5 and 1, more preferably between 0.6 and 1, as determined by the c-OAN/OAN ratio measured according to ASTM D3493-16/ASTM D2414-16 respectively. The c-OAN is preferably 20-200 cc/100 g. This is an advantageously high strength which prevents collapse of the intraporosity even in high-pressure applications.

The surface area of the carbon-nanofiber comprising carbon networks as measured according to the Brunauer, Emmett and Teller (BET) method (ISO 9277:10) is preferably at least 15 m²/g, preferably 15-1000 m²/g, more preferably 20-500 m²/g.

The porous, chemically interconnected, carbon-nanofiber comprising carbon networks may also comprise carbon black particles built in as part of the network. These particles are profoundly found at the junctions between carbon-nanofibers, but there may also be carbon black particles present at other parts of the network. The carbon black particles preferably have a diameter of at least 0.5 times the diameter of the carbon-nanofibers, more preferably at least the same diameter of the carbon-nanofibers, even more preferably at least 2 times the diameter of the carbon-nanofibers, even more preferably at least 3 times the diameter of the carbon-nanofibers, still more preferably at least 4 times the diameter of the carbon-nanofibers and most preferably at least 5 times the diameter of the carbon-nanofibers. It is preferred that the diameter of the carbon black particles is at most 10 times the diameter of the carbon-nanofibers. Such mixed networks are denoted as hybrid networks.

The porous, chemically interconnected, carbon-nanofiber comprising carbon networks have a functionalized surface. In other words, the surface comprises groups that alter the hydrophobic nature of the surface—which is typical for carbon—to a more hydrophilic nature. The surface of the carbon networks comprises carboxylic groups, hydroxylic groups and phenolics. These groups add some polarity to the surface and may change the properties of the compound material in which the functionalized carbon networks are embedded. Without being bound to any theory, it is believed that the functionalized groups bind to the thermoset, for instance by forming H-bonds, and therefore reduce the thermoset chain mobility and increase the glass transition temperature and the resilience of the materials. Hence the mechanical properties, operating window and the durability of the material are enhanced in the final thermoset.

The porous, chemically interconnected, carbon-nanofiber-comprising carbon networks comprise metal catalyst nanoparticles, but only in minute amounts, typically at least 10 ppm based on the weight of the carbon-nanofiber-comprising carbon networks. These are a fingerprint of the preparation method. There is preferred an amount of at most 5000 ppm, more preferably at most 3000 ppm, especially at most 2000 ppm of metal nanoparticles based on the weight of the networks measured by ICP-OES. These metal particles are also embedded in the networks, not to be compared to metal coats applied in the art. These particles may have an average particle size between 1 nm and 100 nm. Preferably said particles are monodisperse particles having deviations from their average particle size which are within 10%, more preferably within 5%. Non-limiting examples of nanoparticles included in the carbon-nanofiber comprising carbon networks are the noble metals (Pt, Pd, Au, Ag), iron-family elements (Fe, Co and Ni), Ru, and Cu. Suitable metal complexes may be (i) platinum precursors such as H₂PtCl₆; H₂PtCl_{6.x}H₂O; K₂PtCl₄; K₂PtCl_{4.x}H₂O; Pt(NH₃)₄(NO₃)₂; Pt(C₅H₇O₂)₂, (ii) ruthenium precursors such as Ru(NO)(NO₃)₃; Ru(dip)₃Cl₂ [dip=4,7-diphenyl-1,10-fenanthroline]; RuCl₃, or (iii) palladium precursors such as Pd(NO₃)₂, or (iv) nickel precursors such as NiCl₂ or NiCl_{2.x}H₂O; Ni(NO₃)₂; Ni(NO₃)_{2.x}H₂O; Ni(CH₃COO)₂; Ni(CH₃COO)_{2.x}H₂O; Ni(AOT)₂ [AOT=bis(2-ethylhexyl)sulphosuccinate], wherein x may be any integer chosen from 1, 2, 3, 4, 5, 6, 7, 8, 9 or 10 and typically may be 6, 7 or 8.

The porous, chemically interconnected, carbon-nanofiber-comprising carbon networks are preferably obtainable by the process for the production of crystalline carbon networks in a reactor 3 which contains a reaction zone 3b and a termination zone 3c, by injecting a water-in-oil or bicontinuous micro-emulsion c, preferably a bicontinuous micro-emulsion c, said micro-emulsion comprising metal catalyst nanoparticles, into the reaction zone 3b which is at a temperature of above 600° C., preferably above 700° C., more preferably above 900° C., even more preferably above 1000° C., more preferably above 1100° C., preferably up to 3000° C., more preferably up to 2500° C., most preferably up to 2000° C., to produce crystalline carbon networks e, transferring these networks e to the termination zone 3c, and quenching or stopping the formation of crystalline carbon networks in the termination zone by spraying in water d.

In a more preferred embodiment, the networks are obtainable by the above process, said reactor being a furnace carbon black reactor 3 which contains, along the axis of the reactor 3, a combustion zone 3a, a reaction zone 3b and a termination zone 3c, by producing a stream of hot waste gas a1 in the combustion zone by burning a fuel a in an oxygen-containing gas b and passing the waste gas a1 from the combustion zone 3a into the reaction zone 3b, spraying a water-in-oil or bicontinuous micro-emulsion c, preferably a bicontinuous micro-emulsion c, said micro-emulsion comprising metal catalyst nanoparticles, in the reaction zone 3b containing the hot waste gas, carbonizing said emulsion at a temperature of above 600° C., preferably above 700° C., more preferably above 900° C., even more preferably above 1000° C., more preferably above 1100° C., preferably up to 3000° C., more preferably up to 2500° C., most preferably up to 2000° C., and quenching or stopping the reaction in the termination zone 3c by spraying in water d, to yield crystalline carbon networks e.

In the above, ‘chemically interconnected’ is understood to mean that the nanofibers are covalently bonded to one another, clearly distinct from physical aggregates.

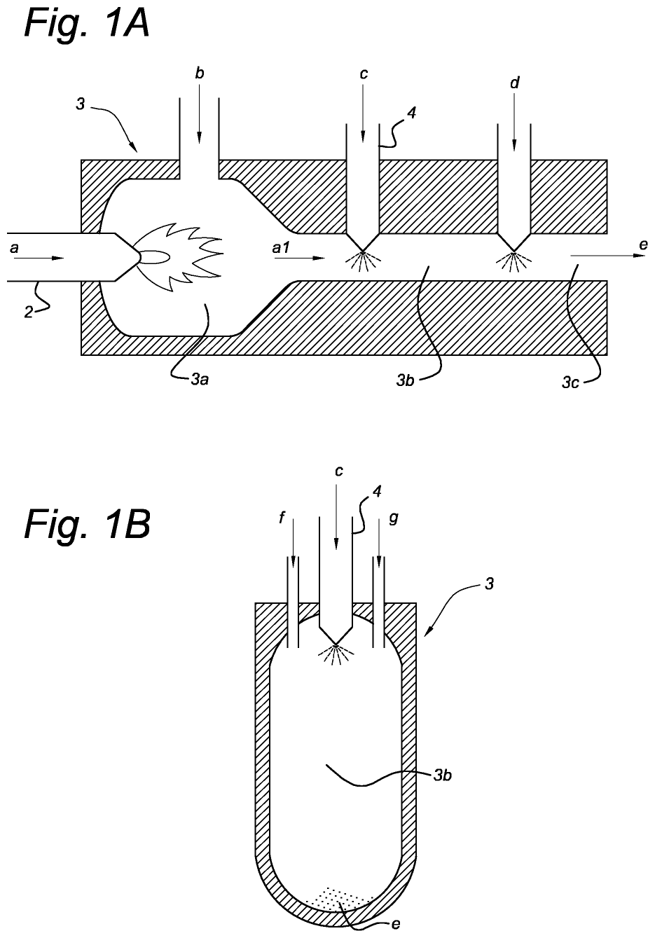

The networks are preferably obtainable by the above process wherein further processing details are provided in the section headed “Process for obtaining carbon-nanofiber-comprising carbon networks” here below, and in FIG. 1A.

Process for Obtaining Carbon-Nanofiber Comprising Carbon Networks

A process for obtaining the porous, chemically interconnected, carbon-nanofiber-comprising carbon networks as described here above can be described best as a modified carbon black manufacturing process, wherein ‘modified’ is understood that a suitable oil, preferably an oil comprising at least 14 C atoms (>C14) such as carbon black feedstock oil (CBFS), is provided to the reaction zone of a carbon black reactor as part of a single-phase emulsion, being a thermodynamically stable micro-emulsion, said micro-emulsion comprising metal catalyst nanoparticles. The thermodynamically stable micro-emulsion is a water-in-oil or bicontinuous micro-emulsion c, preferably a bicontinuous micro-emulsion, said micro-emulsion comprising metal catalyst nanoparticles. The preferred single-phase emulsion comprises CBFS oil, and may be referred to as ‘emulsified CBFS’ in the context of the invention. The water domains should contain a metal catalyst, preferably having an average particle size between 1 nm and 100 nm.

The emulsion is preferably provided to the reaction zone by spraying, thus atomizing the emulsion to droplets. While the process can be carried out batch or semi-batch wise, the modified carbon black manufacturing process is advantageously carried out as a continuous process.

The process for the production of the carbon networks can be performed in a reactor 3 which contains a reaction zone 3b and a termination zone 3c, by injecting a single-phase emulsion c, being a micro-emulsion comprising metal catalyst nanoparticles, preferably a CBFS-comprising emulsion, into the reaction zone 3b which is at a temperature of above 600° C., preferably above 700° C., more preferably above 900° C., even more preferably above 1000° C., more preferably above 1100° C., preferably up to 3000° C., more preferably up to 2500° C., most preferably up to 2000° C., to produce porous, chemically interconnected, carbon-nanofiber-comprising carbon networks, transferring these networks to the termination zone 3c, and quenching or stopping the formation of porous, chemically interconnected, carbon-nanofiber-comprising carbon networks in the termination zone by spraying in water d. The single-phase emulsion is preferably sprayed into the reaction zone. Reference is made to FIG. 1A.

Alternatively the process for the production of the porous, chemically interconnected, carbon-nanofiber-comprising carbon networks is performed in a furnace carbon black reactor 3 which contains, along the axis of the reactor 3, a combustion zone 3a, a reaction zone 3b and a termination zone 3c, by producing a stream of hot waste gas a1 in the combustion zone by burning a fuel a in an oxygen-containing gas b and passing the waste gas a1 from the combustion zone 3a into the reaction zone 3b, spraying (atomizing) a single-phase emulsion c according to the invention, preferably the micro-emulsion comprising metal catalyst nanoparticles as described here above, preferably a CBFS-comprising w/o or bicontinuous micro-emulsion, preferably a bicontinuous micro-emulsion, in the reaction zone 3b containing the hot waste gas, carbonizing said emulsion at increased temperatures (at a temperature of above 600° C., preferably above 700° C., more preferably above 900° C., even more preferably above 1000° C., more preferably above 1100° C., preferably up to 3000° C., more preferably up to 2500° C., most preferably up to 2000° C.), and quenching or stopping the reaction (i.e. the formation of porous, chemically interconnected, carbon-nanofiber-comprising carbon networks) in the termination zone 3c by spraying in water d. The reaction zone 3b comprises at least one inlet (preferably a nozzle) for introducing the emulsion, preferably by atomization. Reference is made to FIG. 1A.

Residence times for the emulsion in the reaction zone of the furnace carbon black reactor can be relatively short, preferably ranging from 1-1000 ms, more preferably 10-1000 ms. Longer residence times may have an effect on the properties of the carbon networks. An example may be the size of crystallites which is higher when longer residence times are used.

In accordance with conventional carbon black manufacturing processes, the oil phase can be aromatic and/or aliphatic, preferably comprising at least 50 wt. % C14 or higher, more preferably at least 70 wt. % C14 or higher (based on the total weight of the oil). List of typical oils which can be used, but not limited to obtain stable emulsions are carbon black feedstock oils (CBFS), phenolic oil, anthracene oils, (short-medium-long chain) fatty acids, fatty acids esters and paraffins. The oil is preferably a C14 or higher. In one embodiment, the oil preferably has high aromaticity. Within the field, the aromaticity is preferably characterized in terms of the Bureau of Mines Correlation Index (BMCI). The oil preferably has a BMCI>50. In one embodiment, the oil is low in aromaticity, preferably having a BMCI<15.

CBFS is an economically attractive oil source in the context of the invention, and is preferably a heavy hydrocarbon mix comprising predominantly C14 to C50, the sum of C14-C50 preferably amounting to at least 50 wt. %, more preferably at least 70 wt. % of the feedstock. Some of the most important feedstocks used for producing carbon black include clarified slurry oil (CSO) obtained from fluid catalytic cracking of gas oils, ethylene cracker residue from naphtha steam cracking and coal tar oils. The presence of paraffins (<C15) substantially reduces their suitability, and a higher aromaticity is preferred. The concentration of aromatics determines the rate at which carbon nuclei are formed. The carbon black feedstock preferably has a high BMCI to be able to offer a high yield with minimum heat input hence reducing the cost of manufacturing. In a preferred embodiment, and in accordance with current CBFS specifications, the oil, including mixtures of oil, has a BMCI value of more than 120. While the skilled person has no difficulties understanding which are suitable CBFS, merely as a guide it is noted that—from a yield perspective—a BMCI value for CBFS is preferably more than 120, even more preferably more than 132. The amount of asphaltene in the oil is preferably lower than 10 wt. %, preferably lower than 5.0 wt. % of the CBFS weight. The CBFS preferably has low sulphur content, as sulphur adversely affects the product quality, leads to lower yield and corrodes the equipment.

It is preferred that the sulphur content of the oil according to ASTM D1619 is less than 8.0 wt. %, preferably below 4.0 wt. % more preferably less than 2.0 wt. %.

Provided that a stable, single-phase w/o or bicontinuous micro-emulsion is obtained, the amounts of water and oil are not regarded limiting, but it is noted that reduced amounts of water (and increased amounts of oil) improve yields. The water content is typically between 5 and 50 wt % of the emulsion, preferably 10-40 wt %, even more preferably up to 30 wt %, more preferably 10-20 wt % of the emulsion. While higher amounts of water can be considered, it will be at the cost of yield. Without wishing to be bound by any theory, the inventors believe that the water phase attributes to the shape and morphology of the networks thus obtained.

The choice of surfactant(s) is not regarded a limiting factor, provided that the combination of the oil, water and surfactant(s) results in a stable micro-emulsion as defined here above. As further guidance to the skilled person, it is noted that the surfactant can be selected on the basis of the hydrophobicity or hydrophilicity of the system, i.e. the hydrophilic-lipophilic balance (HLB). The HLB of a surfactant is a measure of the degree to which it is hydrophilic or lipophilic, determined by calculating values for the different regions of the molecule, according to the Griffin or Davies method. The appropriate HLB value depends on the type of oil and the amount of oil and water in the emulsion, and can be readily determined by the skilled person on the basis of the requirements of retaining a thermodynamically stable, single-phase emulsion as defined above. It is found that an emulsion comprising more than 50 wt % oil, preferably having less than 30 wt % water phase, would be stabilized best with a surfactant having an HLB value above 7, preferably above 8, more preferably above 9, most preferably above 10. On the other hand, an emulsion with at most 50 wt % oil would be stabilized best with a surfactant having an HLB value below 12, preferably below 11, more preferably below 10, most preferably below 9, particularly below 8. The surfactant is preferably selected to be compatible with the oil phase. In case the oil is a CBFS-comprising emulsion with a CBFS, a surfactant with high aromaticity is preferred, while an oil with low BMCI, such as characterized by BMCI<15, would be stabilized best using aliphatic surfactants. The surfactant(s) can be cationic, anionic or non-ionic, or a mixture thereof. One or more non-ionic surfactants are preferred, in order to increase the yields since no residual ions will be left in the final product. In order to obtain a clean tail gas stream, the surfactant structure is preferably low in sulfur and nitrogen, preferably free from sulfur and nitrogen. Non-limiting examples of typical non-ionic surfactants which can be used to obtain stables emulsions are commercially available series of Tween, Span, Hypermer, Pluronic, Emulan, Neodol, Triton X and Tergitol.

The single-phase emulsion, i.e. a w/o or bicontinuous micro-emulsion, preferably a bicontinuous micro-emulsion, further comprises metal catalyst nanoparticles preferably having an average particle size between 1 and 100 nm. The skilled person will find ample guidance in the field of carbon nanotubes (CNTs) to produce and use these kinds of nanoparticles. These metal nanoparticles are found to improve network formation in terms of both rates and yields, and reproducibility. Methods for manufacturing suitable metal nanoparticles are found in Vinciguerra et a1. “Growth mechanisms in chemical vapour deposited carbon nanotubes” Nanotechnology (2003) 14, 655; Perez-Cabero et a1. “Growing mechanism of CNTs: a kinetic approach” J. Catal. (2004) 224, 197-205; Gavillet et a1. “Microscopic mechanisms for the catalyst assisted growth of single-wall carbon nanotubes” Carbon. (2002) 40, 1649-1663 and Amelinckx et a1. “A formation mechanism for catalytically grown helix-shaped graphite nanotubes” Science (1994) 265, 635-639, their contents about manufacturing metal nanoparticles herein incorporated by reference. These metal nanoparticles are embedded in the network.

The metal catalyst nanoparticles are used in the aforementioned bicontinuous or w/o microemulsion, preferably a CBFS-comprising bicontinuous or w/o micro-emulsion. In one embodiment, a bicontinous micro-emulsion is most preferred. Advantageously, the uniformity of the metal particles is controlled in said (bicontinuous) micro-emulsion by mixing a first (bicontinuous) micro-emulsion in which the aqueous phase contains a metal complex salt capable of being reduced to the ultimate metal particles, and a second (bicontinuous) micro-emulsion in which the aqueous phase contains a reductor capable of reducing said metal complex salt; upon mixing the metal complex is reduced, thus forming metal particles. The controlled (bicontinuous) emulsion environment stabilizes the particles against sintering or Ostwald ripening. Size, concentrations and durability of the catalyst particles are readily controlled. It is considered routine experimentation to tune the average metal particle size within the above range, for instance by amending the molar ratio of metal precursor vs. the reducing agent. An increase in the relative amount of reducing agent yields smaller particles. The metal particles thus obtained are monodisperse, deviations from the average metal particle size are preferably within 10%, more preferably within 5%. Also, the present technology provides no restraint on the actual metal precursor, provided it can be reduced. Non-limiting examples of nanoparticles included in the carbon-nanofiber-comprising carbon networks are the noble metals (Pt, Pd, Au, Ag), iron-family elements (Fe, Co and Ni), Ru, and Cu. Suitable metal complexes may be (i) platinum precursors such as H₂PtCl₆; H₂PtCl_{6.x}H₂O; K₂PtCl₄; K₂PtCl_{4.x}H₂O; Pt(NH₃)₄(NO₃)₂; Pt(C5H₇O₂)₂, (ii) ruthenium precursors such as Ru(NO)(NO₃)₃; Ru(dip)₃Cl₂ [dip=4,7-diphenyl-1,10-fenanthroline]; RuCl₃, or (iii) palladium precursors such as Pd(NO₃)₂, or (iv) nickel precursors such as NiCl₂ or NiCl_{2.x}H₂O; Ni(NO₃)₂; Ni(NO₃)_{2.x}H₂O; Ni(CH₃COO)₂; Ni(CH₃COO)_{2.x}H₂O; Ni(AOT)₂ [AOT=bis(2-ethylhexyl)sulphosuccinate], wherein x may be any integer chosen from 1, 2, 3, 4, 5, 6, 7, 8, 9 or 10 and typically is 6, 7 or 8. Non-limiting suitable reducing agents are hydrogen gas, sodium boron hydride, sodium bisulphate, hydrazine or hydrazine hydrate, ethylene glycol, methanol and ethanol. Also suited are citric acid and dodecylamine. The type of metal precursor is not an essential part of the invention. The metal of the particles of the (bicontinuous) micro-emulsion are preferably selected from the group consisting of Pt, Pd, Au, Ag, Fe, Co, Ni, Ru and Cu, and mixtures thereof, in order to control morphology of the carbon structures networks ultimately formed. The metal nanoparticles end up embedded inside these structures where the metal particles are physically attached to the structures. While there is no minimum concentration of metal particles at which these networks are formed—in fact networks are formed using the modified carbon black manufacturing process according to the invention—it was found that the yields increase with the metal particle concentrations. In a preferred embodiment, the active metal concentration is at least 1 mM, preferably at least 5 mM, preferably at least 10 mM, more preferably at least 15 mM, more preferably at least 20 mM, particularly at least 25 mM, most preferably up to 3.5 M, preferably up to 3 M. In one embodiment, the metal nanoparticles comprise up to 250 mM. These are concentrations of the catalyst relative to the amount of the aqueous phase of the (bicontinuous) micro-emulsion.

Atomization of the single-phase emulsion, preferably a CBFS-comprising emulsion, is preferably realized by spraying, using a nozzle-system 4, which allows the emulsion droplets to come in contact with the hot waste gas a1 in the reaction zone 3b, resulting in traditional carbonization, network formation and subsequent agglomeration, to produce carbon networks according to the invention. The injection step preferably involves increased temperatures above 600° C., preferably between 700 and 3000° C., more preferably between 900 and 2500° C., more preferably between 1100 and 2000° C.

In one aspect, the porous, chemically interconnected, carbon-nanofiber comprising carbon networks preferably have at least one, preferably at least two, more preferably at least three, most preferably all of the following properties:
(i) Iodine Adsorption Number (IAN) of 10-1000 mg/g at least 30 mg/g, preferably between 100 and 800 mg/g, even more preferably between 20-500 mg/g according to ASTM D1510;
(ii) Nitrogen Surface Area (N2SA) of at least 15 m²/g, preferably 15-1000 m²/g, more preferably 20-500 m²/g, according to ASTM D6556 and ISO 9277:10;
(iii) Statistical Thickness Surface Area (STSA) of at least 5 m²/g, more preferably 20-500 m²/g, even more preferably 20-300 m²/g, according to ASTM D6556;
(iv) Oil Absorption Number (OAN) of 20-200 cc/100 g, preferably 40-150 cc/100 g according to ASTM D2414,
wherein:
IAN=Iodine Adsorption Number: the number of grams of iodine adsorbed per kilogram of carbon black under specified conditions as defined in ASTM D1510;
N2SA=nitrogen surface area: the total surface area of carbon black that is calculated from nitrogen adsorption data using the B.E.T. theory, according to ASTM D6556;
STSA=statistical thickness surface area: the external surface area of carbon black that is calculated from nitrogen adsorption data using the de Boer theory and a carbon black model, according to ASTM D6556; and
OAN=Oil Absorption Number: the number of cubic centimeters of dibutyl phthalate (DBP) or paraffin oil absorbed by 100 g of carbon black under specified conditions. The OAN value is proportional to the degree of aggregation of structure level of the carbon black, determined according to ASTM D2414.

For each of IAN, N2SA (or NSA), STSA and OAN—all typical parameters for characterizing carbon black materials—the porous, chemically interconnected, carbon-nanofiber comprising carbon networks exhibit superior properties compared to traditional carbon black. The porous, chemically interconnected, carbon-nanofiber comprising carbon networks are preferably characterized by at least one, preferably at least two, more preferably all of (i), (ii) and (iii) since these are typical ways of characterized the surface area properties of the materials. In one embodiment, the porous, chemically interconnected, carbon-nanofiber comprising carbon networks exhibit at least one of (i), (ii) and (iii), and further comply with (iv).

Processes for Reinforcing a Thermoset Material

The invention hence relates to reinforcing a thermoset material using the above described carbon networks. In order to produce a reinforced thermoset material according to the invention, the carbon nanofiber-comprising carbon networks as described above are mixed with a liquid, uncured thermoset resin. Said mixing may be performed in an industrial mixer such as a high viscosity mixer, an impeller mixer, a shear mixer, a ribbon blender, a jet mixer, a vacuum mixer, or any other suitable mixer. The improved dispersibility has its effect not only on the reinforced thermoset ultimately formed, but also facilitates the manufacturing process. Additional reinforcing agents may be added at this stage. The mixing step is subsequently followed by curing of the resins. The curing conditions may be a specific temperature (i.e. heat) or irradiation by UV-light but these are known to the skilled person, and remain unchanged. If beneficial a catalyst and/or a hardener may be used.

The thermoset resin may be shaped or moulded using a mould. Suitable processes include transfer moulding, injection moulding and compression moulding. In each of these processes the thermoset resin comprising the carbon networks is brought into a mould where it cures in order to form a manufactured article comprising the reinforced thermoset material of the invention.

### EXAMPLES

### Example 1: Surface Resistivity

Two different grades of carbon networks (X1 and X7) were prepared according to the manufacturing process including recipe of example 1 in WO2018/002137, its contents herein incorporated by reference.

The Fe metal particles are below 1300 ppm for the grades used in these examples. The X1 grade was obtained using a tread-reactor and the X7 grade was obtained using a carcass reactor. Both are common reactors in the field of carbon black manufacturing. The variation in the manufacturing process can be attributed to the different reactor used carcass (longer residence times) and tread (shorter residence times).

| Grade | Residence time* | |
|---|---|---|
| XR-1 | ~250 | ms |
| X7-P | 414-816 | ms |

*Theoretical model

Specifications X1 and X7 Grades of Carbon Networks According to the Invention

| | | | X7 | X1 |
|---|---|---|---|---|
| OAN | ASTM D2414 | cc/100 g | 75 | 47 |
| c-OAN | ASTM D3493 | cc/100 g | 67 | 44 |
| IAN | ASTM D1510 | g/kg | 45 | 106 |
| Total N2SA (BET) | ASTM D6556 | m²/g | 40.5 | 107.6 |
| External STSA | ASTM D6556 | m²/g | 40.1 | 117.1 |
| V total pores | ASTM D 4404-10 | cm³/g | 0.95 | 1.38 |
| V intra particle pores | ASTM D 4404-10 | cm³/g | 0.61 | 0.58 |
| d intra particle pores | ASTM D 4404-10 | Um | 0.07 | 0.02 |
| d inter particle pores | ASTM D 4404-10 | Um | 250 | 83 |
| % porosity | ASTM D 4404-10 | % | 64 | 71 |
| Tint strength | ASTM D3265 | | 61 | 131 |
| Tr % | ASTM D1618 | % | 99.40 | 99.00 |
| | Internal | % | 65.70 | 92.48 |
| Sulfur content | | % | 0.64 | 0.60 |
| Fe | ICP-OES | ppm | 1248 | 871 |
| % ash | ASTM D1506 | % | 0.30 | 0.57 |
| Sieve residues (45 um) | ASTM D1514 | mg/kg | 88 | 393 |
| pH | ASTM 1512 | a.u. | 7.00 | 5.53 |
| True density | DIN 66137-2 | g/cm3 | 1.90 | 1.94 |
| Moisture as packed | | % | 0.20 | 0.45 |
| Structure diameter | TEM | Nm | 74.00 | 39.90 |
| (average) | | | | |
| | | St.dev.± | 12.30 | 4.70 |
| La | XRD | Å | 25.50 | 27.20 |
| Lc | XRD | Å | 17.80 | 16.70 |
| d-spacing | XRD | Å | 3.61 | 3.64 |
| Polyaromatics | | | | |
| Sum PAHs | AfPS GS 2014:01 | Ppm | 38.80 | 11.10 |
| | PAK | | | |
| Particle size | | Nm | 15-100 | 20-115 |

Epoxy composite was prepared by adding the appropriate amount of these carbon networks to the epoxy resin (Biresin CR83). The carbon network material was dispersed (dispersion is monitored by Hegman Grindometer) into the resin using a planetary speedmixer (Hauschildt DAC 400.2 VAC-P) by mixing at 2500 rpm for 10-15 minutes. The appropriate amount of hardener (Biresin CH83-10) was added to the composite and mixed using the speedmixer (2500 rpm for 1 min). The composite was cast into a PTFE mould and cured for 16 hours at 80° C.

The surface resistivity of the resulting epoxy composite was measured using a picoammeter (Keithley 6487) using an internal method. A conductive silver-paint was applied in two 5.0×0.1 cm lines, which were 1.0 cm apart. A specified voltage was applied across those 2 lines, and the resulting current was recorded. The values were converted into a surface resistivity value (0/sq).

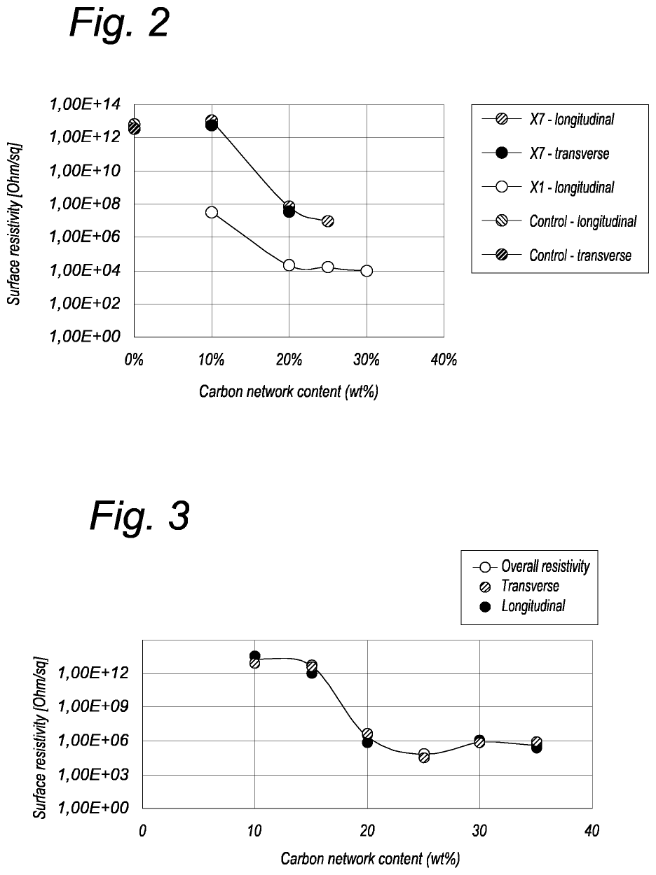

The surface resistivity results are plotted in FIG. 2.

### Example 2: Surface Resistivity

Water-based polyurethane composite coating was prepared by adding the appropriate amount of carbon network material as prepared in example 1 to the water based polyurethane composite coating (Aqua PU Iak, Avis). The carbon networks were dispersed (dispersion is monitored by Hegman Grindometer) into the coating using a planetary speedmixer (Hauschildt DAC 400.2 VAC-P) by mixing a total of 10-15 min at 2500 rpm (whilst keeping the temperature below 40° C.). The coating was applied to a ceramic tile and left to dry. The surface resistivity of the resulting composite coating was measured using a picoammeter (Keithley 6487) using an internal method. A conductive silver-paint was applied in two 5.0×0.1 cm lines, which were 1.0 cm apart. A specified voltage was applied across those 2 lines, and the resulting current was recorded. The values were converted into a surface resistivity value (Q/sq).

The surface resistivity results are plotted in FIG. 3. The filler content on the x-axis corresponds to the carbon network loading.

### Example 3: Tg

Epoxy composite was prepared by adding the appropriate amount of carbon network material as prepared in example 1 to the epoxy resin (EPIKOTE Resin MGS RIMR 135). In some cases an appropriate amount of wetting agent was added (Borchers Gen DFN). The carbon network material was dispersed (dispersion was monitored by Hegman Grindometer) into the resin using a planetary speedmixer (Hauschildt DAC 150.1 FV) by mixing at 3500 rpm for 11 minutes. The appropriate amount of hardener (EPIKURE curing agent MGS RIMH 137) was added to the composite and mixed using the planetary speedmixer (3500 rpm for 1.5 min). The composite was cast into a mould and cured for 16 hours at 80° C. to produce dogbones.

Glass transition temperatures (T₉) of the epoxy composites were determined on a Netzsch Polyma 214 DSC. Temperature program: 20° C. to 180° C. using at a heating rate of 10° C./min. The results are given in the table below.

| | | Tg onset | Tg mid |
|---|---|---|---|
| wt % | Carbon network grade | [° C.] | [° C.] |
| 0 | clear cast | 81.9 | 87.6 |
| 30 | X7 | 84.6 | 91.1 |
| 30 | X1 | 87.1 | 91.0 |
| 12.5 | X7 | 86.5 | 93.6 |
| 12.5 | X7 | 86.6 | 92.9 |
| 17.5 | X7 | 86.1 | 91.8 |
| 20 | X7 | 86.9 | 92.3 |

### Example 4: Tensile Strength

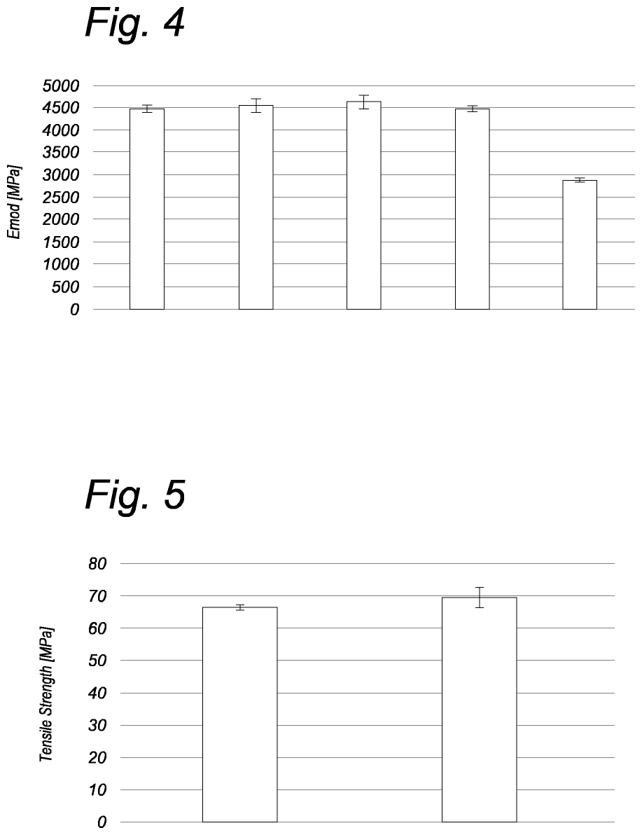

Epoxy composite was prepared by adding the appropriate amount of carbon network material as prepared in example 1 to the epoxy resin (EPIKOTE Resin MGS RIMR 135). In some cases an appropriate amount of wetting agent has been added (BYK W980). The carbon network material was dispersed (dispersion was monitored by Hegman Grindometer) into the resin using a planetary speedmixer (Hauschildt DAC 150.1 FV) by mixing at 3500 rpm for 11 minutes. The appropriate amount of hardener (EPIKURE curing agent MGS RIMH 137) was added to the composite and mixed using the planetary speedmixer (3500 rpm for 1.5 min). The composite was cast into a mould and cured for 16 hours at 80° C. to produce dogbones. Tensile tests according to ISO 527 were conducted on these dogbones. The samples were tested on a Zwick/Roell tensile tester (1475 WN:115401; Crosshead travel monitor WN:115401; Force sensor ID:0 WN:115402 100 kN; Macro ID:2 WN:115403). Test speed: 1 mm/min. These tensile tests resulted in the tensile strength and E-modulus data and tensile strength (FIGS. 4 and 5, respectively). FIG. 4 plots the Emodulus for X7 and X1 in epoxy, from left to right:
30 wt % X1/epoxy;
30 wt % X1/epoxy and wetting agent;
30 wt % X7/epoxy;
30 wt % X7/epoxy and wetting agent; Control.

FIG. 5 plots the tensile strength for 30 wt % X7/epoxy (right) compared to the epoxy control (left).

### Example 5: Thermal Conductivity

Epoxy composite was prepared by adding the appropriate amount of carbon network material as prepared in example 1 to the epoxy resin (Biresin CR83). The carbon networks were dispersed (dispersion was monitored by Hegman Grindometer) into the resin using a planetary speedmixer (Hauschildt DAC 400.2 VAC-P) by mixing at 2500 rpm for 10-15 minutes. The appropriate amount of hardener (Biresin CH83-10) was added to the composite and mixed using the speedmixer (2500 rpm for 1 min). The composite was cast into a PTFE mould (4×100×75 mm) and cured for 16 hours at 80° C. The in-plane thermal conductivity was determined by a THISYS thermoconductivity measurement system from Hukseflux.

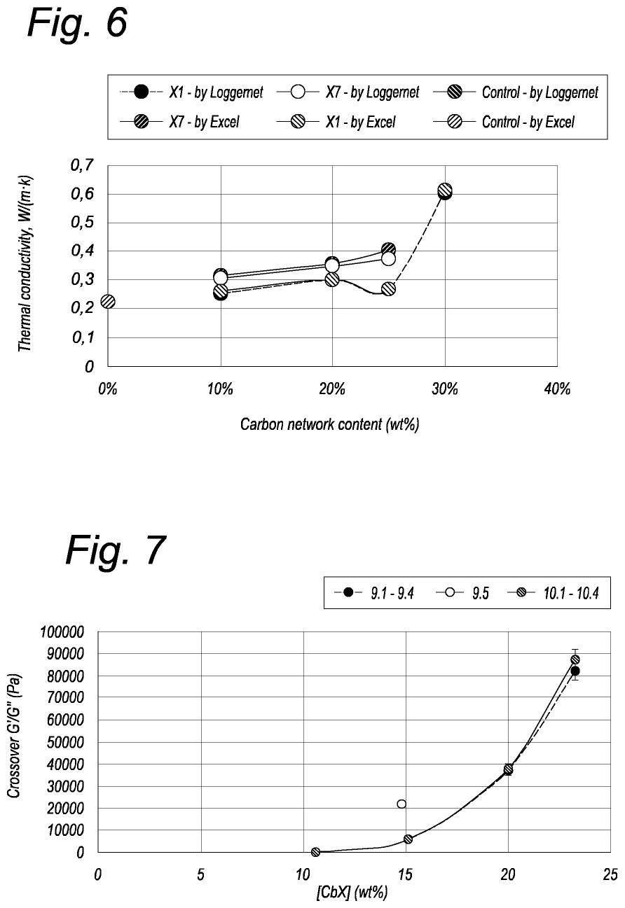

The thermoconductivity results are plotted in FIG. 6.

### Example 6: Crossover G′/G″

Oscillatory Rheology was utilised to probe the microstructure (inter particle network) of the composite material. A microstructure implies that forces exist between the particles in the composite. A force larger than the force that keeps the particles together needs to be applied to break the inter particle network. G′ is larger than G″ when the applied force is smaller than the inter particle forces. But when the applied force is higher, then the inter particle network collapses and the mechanical energy given to the material is dissipated, meaning that the material flows, which is the force where G″ becomes larger than G′.

Samples were prepared by mixing appropriate amounts of carbon network material X1 as prepared in example 1 into epoxy resin (Biresin CR83) using a high shear mixer (Ultraturrax IKA T18, with an IKA S18N 19G dispersing tool). Rheology experiments were performed on an Anton Paar MCR92 with P-PTD100 air cooler and a conical spindle (CP50-1, diameter 49.983 mm, angle 1.012°, cone truncation 102 μm) at 25° C. with a strain-range of 0.01-100% and an angular frequency of 10 rad/s.

The crossover results are plotted in FIG. 7. The point at 15 wt % network loading [CBX] with a crossover of about 2000 Pa is the Vulcan/epoxy reference.

### Example 7: Heating Element

Epoxy composite was prepared by adding the appropriate amount of Carbon network (grade X7) material (40 wt %) to the epoxy resin (EPIKOTE Resin MGS RIMR 135). A wetting agent was added (BYK W980). The Carbon networks were dispersed (dispersion was monitored by Hegman Grindometer) into the resin using a planetary speedmixer (Hauschildt DAC 150.1 FV) by mixing at 3500 rpm for 11 minutes. The appropriate amount of hardener (EPIKURE curing agent MGS RIMH 137) was added to the composite and mixed using the planetary speedmixer (3500 rpm for 1.5 min). The composite was cast between two glass plates together with two copper sheet electrode connection points and cured for 16 hours at 80° C. to produce a 4 mm thick sheet (i.e, heating element).

The heating element that is described above had a resistance between the two copper electrodes of 1.2 kΩ. It was powered by a standard European wall socket (230V, AC 50 Hz, 44 W), which resulted in heating up the plate to >50° C. within minutes, after which the power was switched off.

### Example 8: Comparison Between Carbon Networks According to the Invention and CVD-Produced Networks According to US2013/244023

Networks are produced with the same emulsion composition, but with the production settings of a CVD process as described in US 2013/244023, and with the production settings of a furnace black process. In both cases, the emulsion composition is as described in the experimental parts of WO2018/002137:
a) Carbon Black slurry oil (CBO or CBFS oil)
b) Water phase containing 3500 mM metal precursor salt (FeCl2)
c) Water phase containing reducing agent (3650 mM citric acid)
d) Surfactant (TritonX; HLB 13.4).

In each case, the emulsions were introduced in the middle of a quartz-tube of a thermal horizontal tube reactor.

The CVD reactor was heated up to 750° C. (3 K/min) under 130 seem of nitrogen flow and kept for 90 min at the same temperature. In the first 60 min the nitrogen gas flow was reduced to 100 sccm and ethylene gas was added at 100 sccm flow. During the last 30 minutes at 750° C. the ethylene was purged out from nitrogen at 130 sccm for the last 30 min and the reactor was then cooled down.
Fiber length>300 nm
Diameter: 50-250 nm

For the furnace black process, N110 settings were applied:

| | Feedstock | | Combustion | Combustion | Residence |
|---|---|---|---|---|---|
| Based | flowrate | CH4 rate | Air rate | air temp | time+ |
| on | [t/h] | [Nm3/h] | [Nm3/h] | [C.] | [ms] |
| N110 | 2 | 485 | 7000 | 620 | 22 |

Fiber length: 30-300 nm
Diameter: 10-50 nm

In both cases, networks were formed. However, the ‘CVD-produced’ carbon networks yielded high conductivity and reinforcement (see graph 9a and 9b in US2013/244023) at low loadings <5% wt. These results are obtained with PI and PMMA. Those can be compared to the performance of the carbon networks as described in WO2018/002137: From the results plotted for PA6 there, it can be derived that loadings of 5-10 wt % were needed to achieve the same high stiffness and conductivity.

1.-16. (canceled)

17. A method for reinforcing a thermoset material wherein at least 0.1 wt % of porous, chemically interconnected, carbon-nanofibers-comprising carbon networks are provided to and reinforce a thermoset material, said weight based on the total weight of the reinforced thermoset material, wherein the reinforced thermoset material comprises additional reinforcing agent(s), wherein the total amount of carbon networks and the additional reinforcing agent(s) is between 1 and 75 wt % of the total weight of the reinforced thermoset material.

18. The method according to claim 17, wherein the amount of additional reinforcing agent(s) is between 1 and 45 wt %, based on the total weight of the reinforced thermoset material.

19. The method according to claim 17, wherein the amount of said carbon networks is between 5 and 60 wt % said weight based on the total weight of the reinforced thermoset material.

20. The method according to claim 19, wherein the networks are provided in an amount of 5-45 wt %, said weight based on the total weight of the reinforced thermoset material.

21. The method according to claim 17, wherein the further reinforcing agent comprises carbon fibers, glass fibers, aramids, natural fibers, carbon nanotubes, carbon nanofibers, silicon nanotubes, nanoclays.

22. A reinforced thermoset material comprising at least 0.1 wt % of porous, chemically interconnected, carbon-nanofiber-comprising carbon networks, the reinforced thermoset material comprising additional reinforcing agent(s), wherein the total amount of carbon networks and reinforcing agent(s) other than said carbon networks is between 1 and 75 wt % of the total weight of the reinforced thermoset material.

23. The reinforced thermoset material according to claim 21, wherein the amount of further reinforcing agent is between 1 and 45 wt %, based on the total weight of the reinforced thermoset material.

24. The reinforced thermoset material according to claim 21, wherein the carbon networks comprise crystalline carbon-nanofibers.

25. The reinforced thermoset material according to claim 21, wherein the carbon networks are intraparticle porous networks.

26. The reinforced thermoset material according to claim 21, wherein the average fiber length of the carbon-nanofibers is 30-10,000 nm.

27. The reinforced thermoset material according to claim 21, wherein the thermoset material is any one of unsaturated polyester resin, vinyl ester resin, epoxy, phenolic, urethane, polydicyclopentadiene, cyanate esters (CEs), bismaleimides (BMIs), silicons, melamine formaldehyde, phenol formaldehyde, urea formaldehyde, diallyl phthalate, benzoxazines, polyimides, furan resins, or polyamides.

28. The reinforced thermoset material according to claim 21, wherein the carbon networks are obtainable by a process for producing crystalline carbon networks in a reactor 3 which contains a reaction zone 3b and a termination zone 3c, by injecting a water-in-oil or bicontinuous micro-emulsion c comprising metal catalyst nanoparticles, into the reaction zone 3b which is at a temperature of above 600° C., to produce crystalline carbon networks e, transferring these networks e to the termination zone 3c, and quenching or stopping the formation of crystalline carbon networks in the termination zone by spraying in water d.

29. An article of manufacture comprising the reinforced thermoset material according to claim 21, said article being a coating, an adhesive, a reinforcing element, a heating element, automotive part or a construction element, or a lightweight reinforced radiator for wind turbines and airplane.

30. The article according to claim 28, wherein the carbon networks are intraparticle porous networks wherein the carbon nanofibers are interconnected to other carbon nanofibers in the networks by chemical bonds via junctions, wherein the pores in the networks have an intraparticle pore diameter size of 5-150 nm using Mercury Intrusion Porosimetry according to ASTM D4404-10, wherein at least 20 wt % of the carbon in the carbon networks is in crystalline form, and the carbon nanofibers have an average aspect ratio of fibre length-to-thickness of at least 2.
